(19) United States
(12) Patent Application Publication
(10) Pub. No.: US 2015/0218027 A1
(43) Pub. Date: Aug. 6, 2015

(54) Treatment method and plant for petroleum refinery process effluents

(71) Applicant: BERNARDINELLO ENGINEERING S.P.A., Cadoneghe (IT)

(72) Inventor: Federico Nicolazzi, Cadoneghe (IT)

(73) Assignee: BERNARDINELLO ENGINEERING S.P.A., Cadoneghe (IT)

(21) Appl. No.: 14/430,211

(22) PCT Filed: Sep. 24, 2013
(86) PCT No.: PCT/IB2013/002109

§ 371 Date: Mar. 21, 2015

(30) Foreign Application Priority Data
Sep. 24, 2012 (IT) VE2012A000035

(51) Int. Cl. C02F 9/00; B01D 53/18

(52) U.S. Cl. CPC C02F 9/00; B01D 53/18; C02F 2001/422

(57) ABSTRACT

A treatment method for petroleum refinery process effluents includes the steps of mechanical filtration of effluent from SWS, adsorption of the organic substances present in the effluent and potentially harmful for technologies applied in subsequent steps, and total demineralization of the effluent, including decationization with at least one ion exchange resin, subsequent decarbonation step, and deanionization with at least two ion exchange resins, of which one is weak and one is strong.

### FIELD OF THE INVENTION

The present invention relates to a treatment method and a treatment plant for petroleum refinery process effluents.

### BACKGROUND OF THE INVENTION

In petroleum refineries, pretreatment plants are known for the water originating from processes and containing harmful and toxic substances. These pretreatment plants are known as SWS (Sour Water Strippers), consisting essentially of steam stripping systems. The water from these is generally mixed with the other discharge water from the refinery and fed to effluent treatment.

This water originating from SWS, generally at a temperature between 50° C. and 90° C., contains numerous substances (in particular phenols, cyanides, substituted amines, ammonia, sulphides, etc.) toxic for the bacterial load contained in effluent treatment plants, and also contain substances (for example selenium) which cannot be treated by said plants, and therefore reach the receiving waters.

It is known to use water originating from SWS for desalination treatment of refinery crude. This represents a use, on termination of which the water is mixed with other refinery discharge waters and sent to effluent treatment.

A drawback of known treatment methods for water originating from SWS is the presence therein of contaminants which cause disturbances to the biological plant, as they are toxic for the bacterial loads.

Another drawback is the presence in the SWS water of parameters which, under certain conditions (for example on sudden concentration changes) can preclude the operability of the effluent treatment plant, in particular of the biological plant.

Another drawback is the considerable loss of good quality water which could be easily recovered.

Another drawback is the presence in the discharge water of contaminants which the effluent treatment plant, and in particular of the biological plant, are unable to treat or at most only insufficiently treat.

U.S. Pat. No. 7,282,152 describes a method for removing selenium from water from SWS; this method does not effect total demineralization of the water, and in fact specifically states that ion exchange with resins does not constitute an effective removal technique, in that the selenites present in the waters to be treated present an affinity for resins which is virtually identical to that of sulphates, also present in the water to be treated. As sulphates are present in a much greater quantity than the selenites, these compete preferentially with the selenites in the resin sites.

US 2005/0079114 describes a method for removing selenium from water from SWS. In this method a specific filter for selenium is required and is essential since it removes the greatest part of the selenium. Moreover, when the strong anionic resin is used, this latter alone removes not more than 25% of selenium and the total removal obtained by the combination of said filter with the strong anionic resin is never more than 90%.

### SUMMARY OF THE INVENTION

An object of the invention is to propose a treatment method for the water originating from SWS of a refinery, able to overcome all the aforesaid drawbacks.

A particular object of the invention is to propose a treatment method for the water originating from SWS, able to separate from the effluent all the contaminants present and to recover hot demineralized water.

An object of the invention is to propose a treatment method for the water originating from SWS of a refinery, able to overcome all the aforesaid drawbacks.

Another object of the invention is to propose a plant for implementing the method.

These objects and others which will be apparent from the ensuing description are attained, according to the invention, by a treatment method for petroleum refinery process effluents, as described hereinafter.

Again according to the invention, the method can be implemented in a plant as described hereinafter.

### BRIEF DESCRIPTION OF THE DRAWING

The present invention is further clarified hereinafter with reference to a preferred embodiment thereof, provided with reference to the accompanying

FIG. 1 of the drawing, showing a block diagram of the method of the invention.

### DETAILED DESCRIPTION OF EMBODIMENTS OF THE INVENTION

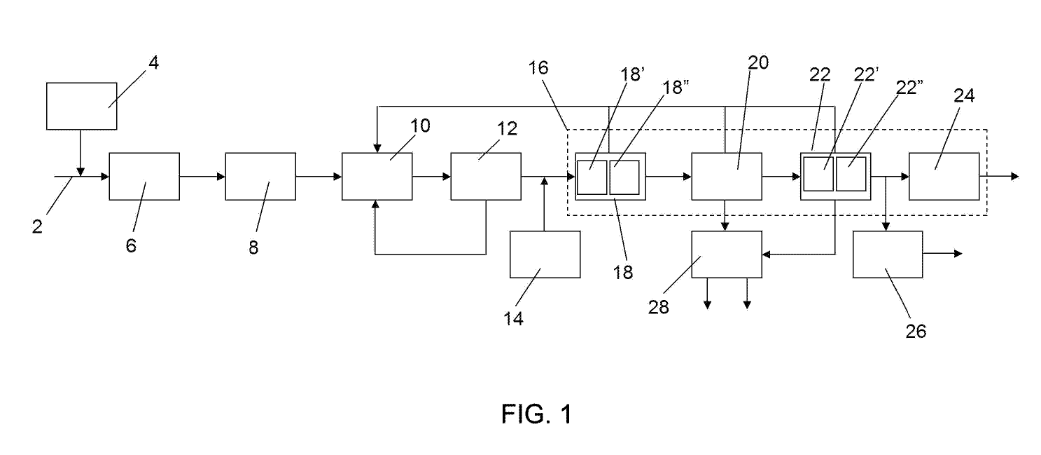

As can be seen from FIG. 1, a method according to the invention is applicable to effluents from SWS units of a petroleum refinery, and comprises a series of essential steps which, depending on the actual case, can be integrated with preferential steps intended to adapt the method to different characteristics of the effluent to be treated, this latter being related to the refinery itself and more particularly to the type of crudes treated and to the refinery plant characteristics.

An oxidant 4 (sodium hypochlorite, calcium hypochlorite, hydrogen peroxide, potassium permanganate, chlorine dioxide, chlorine gas, ozone and its derivatives) is added to the effluent to be treated 2, originating under pressure from SWS, generally at a temperature between 50 and 90° C., in order to oxidize a part of the organic and inorganic substances contained in the effluent, with the double advantage of removing certain inorganic substances and of reducing the COD due to the organic substances. Although not essential, this step of adding an oxidant to the effluent, in any event appears advantageous in the light of the aforegoing.

The effluent, possibly with added oxidant, is then subjected to mechanical filtration in a physical filter 6 (of self-cleaning sand type) and is then cooled in a heat exchanger 8 with demineralized water, advantageously consisting, as will be more apparent hereinafter, of the same demineralized water as obtained with the method according to the invention. In reality the cooling step is not essential, but is advantageously carried out for the double purpose of recovering usable heat and of making its temperature compatible with the technology used in the downstream treatment steps. In particular, if in the subsequent decarbonation steps gas-permeable membranes are used, the maximum allowable temperature for the effluent should not exceed 45° C. and preferably 35° C. If air strippers are used in the decarbonation steps instead of permeable membranes, effluent cooling does not seems necessary for this purpose. In an alternative embodiment, the invention comprises oxidizing the effluent after the cooling step instead of before the filtration step.

The effluent is then stored in a tank 10 or in a basin of such capacity as to enable the water partially treated by the downstream section to be recovered. This is because some of the subsequent sections of the plant involve steps in which water is produced of a quality not always satisfying specifications. In this case the tank enables this water to be stored and be treated instead of being discharged.

The oxidized stored effluent is then fed to a bank of filters 12 containing an adsorbent substance (activated carbon, anthracite, adsorbent polymers) able to remove traces of organic substances of large dimensions or which are harmful to the technologies applied in the downstream sections.

Downstream of the adsorbent, a reducing substance 14 (sodium bisulphite, sulphites, hydrogen sulphide, etc.) can be advantageously added to neutralize any residual oxidant. More particularly, the addition of the reducing substance is related to the type of adsorbent substance used: if a reducing adsorbent substance is used (activated carbon or anthracite) there is no point in adding further reducing substance, whereas if a non-reducing adsorbent substance is used (adsorbent polymers) the reducing substance has necessary to be added.

The wash water of the adsorbent filters 12 is then fed to the storage tank 10 for subsequent reprocessing.

Downstream of this pretreatment step an ion exchange demineralization step is provided. The step of total demineralization of the effluent comprises decationization with at least one ion exchange resin, subsequent decarbonation step, and deanionization with at least two ion exchange resins, of which one is weak and one is strong.

This is carried out in a demineralization unit 16, itself comprising a decationization unit with at least one ion exchange resin, a decarbonation unit and a deanionization unit with at least two ion exchange resins, of which one is weak and one is strong. More particularly, the demineralization unit 16 comprises four successive sections:

a cationic section 18,

a decarbonation section 20,

an anionic section 22,

a refining (polishing) section 24.

The cationic section 18 comprises two series-connected cationic units 18′, 18″ which can contain, depending on the effluent to be treated, either two separate resins or the same resin.

If the two cationic units 18′, 18″ contain two different resins, the first unit 18′ contains weak or strong microporous or gelular cationic resins, while the second unit 18″ contains strong microporous or gelular cationic resins. In any event, resin regeneration is provided, which takes place in the reverse direction to the working direction (counter-current), i.e. first in the second unit 18″ and then in the first 18′.

The two cationic units 18′ and 18″ can be physically separated and be connected together by pipes, or can be installed in the same column, and the resin regeneration be carried out with hydrochloric acid, sulphuric acid or nitric acid, at choice.

The eluate obtained from the resin regeneration is separated into fractions on the basis of the residual conductivity and, depending on the specific characteristics, can be fed for recovery to the tank 10 and then reprocessed, or to disposal as such, or to subsequent concentration in an evaporator/concentrator 26.

The purpose of the decarbonation section 20 of the ion exchange demineralization unit 16 is to remove the volatile substances which could form an ionic load to be treated in the next steps. In particular the decarbonation section 20 can consist of an air stripping column or gas permeable membranes. In both cases the stripped air can be after-treated, for safety reasons, before being fed to atmosphere. The after-treatment consists preferably of removal by means of a scrubber 28 using an alkaline substance, for example sodium hydroxide. The scrubber 28 can be advantageously fed with an alkaline substance, for example sodium hydroxide, which is either fresh or is obtained by regeneration from the anionic section 22 of the demineralization unit 16.

The anionic section 22 comprises two separate anionic units 22′, 22″, which contains two separate resins.

In particular, the first unit 22′ contains weak or strong microporous or gelular anionic resin, while the second unit 22″ contains strong microporous or gelular anionic resin. Again in this case, as in the case of the cationic section 18, resin generation takes place in the reverse direction to the working direction (counter-current), i.e. first in the second unit 22″ and then in the first 22′. Moreover the two units 22′ and 22″ can be physically separated and be connected together by pipes, or be installed in the same column.

Regeneration can be carried out independently with sodium hydroxide, with potassium hydroxide, or with ammonia.

The eluate obtained from the resin regeneration is separated into fractions on the basis of the residual conductivity and, depending on the specific characteristics, can be fed to recovery in the tank 10 and then reprocessed, or to disposal as such, or to subsequent concentration in an evaporator/crystallizer

The purpose of the refining section 24 of the ion exchange demineralization unit 12 is to form a final barrier in the treatment chain, able to ensure that all parameters fall within the scheduled limits. In particular the conductivity, and the silica, selenium, arsenic and vanadium contents are monitored.

This refining section 24 can consist of a mixed bed ion exchange unit, or of a selective unit or a combination of the two.

The mixed bed unit consists of a mixture of cationic ion exchange resins mixed in adequate proportions with anionic resins. Before carrying out regeneration of the resins, these are separated from each other by utilizing the ion exchange unit, or of a selective unit or a combination of the two.

The mixed bed unit consists of a mixture of cationic ion exchange resins mixed in adequate proportions with anionic resins. Before carrying out regeneration of the resins, these are separated from each other by utilizing their different densities and are then traversed by acid and alkaline solutions exactly in the same manner as the resins of the upstream section.

The selective unit is used in particular for removing selenium, arsenic and vanadium, and uses materials able to fix these substances selectively by means of active sites present in the materials themselves. In particular, activated manganese dioxide of natural origin (pirolusite) can be used, or one of the materials known as GFH (granulated ferric hydroxide) or GEH (commercial name) can be used.

With an experimental plant constructed and used in accordance with the principles of the present invention, the following results were obtained:

production of demineralized water from SWS effluents 92-97%; the demineralized water can then be used to extract heat from the effluent originating from the SWS;

ammonia and selenium removal >99%;

segregation and recovery ammoniacal eluates >98%;

reduction of organic load (COD) >90%;

low plant and running cost.

Essentially the present invention is based on a principle which is totally different from that on which US 2005/0079114 is based and is such as to effect preliminary removal of sulphates (and other strong anions) from the SWS effluents, hence preventing the selenates competing with these anions, to finally obtain water not only free of selenium but also of any other salt.

By virtue of the invention the following objectives can be achieved:

recovery of residual heat for heating the demineralized water produced or already stored in a final tank;

separating of certain organic substances (containing or not containing nitrogen) in the adsorption unit;

separation of ammonium and amine cations and their segration in an acid concentrate;

separation of selenium, vanadium and arsenic anions, of a part of the COD and of the organic nitrogen, and their segration in an akaline concentrate;

concentration of one or more solutions to obtain a solid disposable in accordance with law;

production of demineralized water with characteristics compatible with industrial boiler feed.

1.-31. (canceled)

32. A treatment method for petroleum refinery process effluents originating from sour water strippers, comprising:
mechanically filtering an effluent originating from a sour water stripper;
adsorbing organic substances present in the effluent which are potentially harmful for a technologies applied in a subsequent step; and
totally demineralizing the effluent by in sequence decationizing with at least one ion exchange resin, decarbonazing by degassing, and deanionizing with at least two ion exchange resins, of which one is weak and one is strong.

33. The treatment method as claimed in claim 32,
wherein, in the step of demineralizing, the effluent already subjected to the step of adsorbing organic substances is regenerated by passage through at least one decationization unit, a subsequent degassing section, at least one deanionization unit, and a final refining section, and
wherein, by subjecting to regeneration cationic resins contained in the decationization unit and anionic resins contained in the deanionization unit, an eluate obtained from the regeneration is then subjected to concentration before disposal.

34. A treatment plant for petroleum refinery process effluents originating from sour water strippers, comprising:
a mechanical filter for an effluent originating from a sour water stripper;
an adsorption unit, downstream of the mechanical filter, for organic substances present in the effluent; and
downstream of the adsorption unit, a demineralization unit that comprises in sequence a decationization unit with at least one ion exchange resin, a decarbonation unit which is a degassing section, and a deanionization unit with at least two ion exchange resins, of which one is weak and one is strong.

35. The treatment plant as claimed in claim 34, further comprising, downstream of the mechanical filter, a cooling unit that cools the effluent with demineralized water.

36. The treatment plant as claimed in claim 35, wherein the treatment plant is configured to add an oxidant upstream of said mechanical filter or downstream of said cooling unit.

37. The treatment plant as claimed in claim 35, further comprising a storage tank downstream of the cooling unit, of the adsorption unit, or of one of the decarbonation unit, degassing section, or deanionization unit of the demineralization unit.

38. The treatment plant as claimed in claim 34, wherein the adsorption unit comprises a bank of filters containing an adsorbent substance.

39. The treatment plant as claimed in claim 38, wherein the treatment plant is configured to reprocess wash water of the filters within the treatment plant.

40. The treatment plant as claimed in claim 34, wherein the demineralization unit further comprises a refining section.

41. The treatment plant as claimed in claim 40, wherein the refining section comprises a first unit having a mixture of cationic ion exchange resin with anionic ion exchange resin, and a second unit having materials with active sites that selectively fix substances to be removed.

42. The treatment plant as claimed in claim 34, wherein the decationization unit comprises two cationic units connected in series and each containing a resin, or the deanionization unit comprises two anionic units connected in series and each containing a resin.

43. The treatment plant as claimed in claim 42, wherein one cationic unit contains a weak or strong microporous or gelular cationic resin and the other cationic unit contains a strong microporous or gelular cationic resin, or wherein one anionic unit contains a weak microporous or gelular anionic resin and the other anionic unit contains a strong microporous or gelular anionic resin.

44. The treatment plant as claimed in claim 34, wherein the deanionization unit comprises two separate anionic units, which contain two separate resins, and wherein the first anionic unit contains a weak anionic resin and the second anionic unit contains a strong anionic resin.

45. The treatment plant as claimed in claims from 34, further comprising, downstream of the decarbonation unit, a scrubber using an alkaline substance.

46. The treatment plant as claimed in claim 34, further comprising an evaporator/crystallizer, downstream of the decationization unit or deanionization unit, configured to evaporate/crystallize an eluate obtained from regeneration of a resin thereof.
